(19) United States
(12) Patent Application Publication
(10) Pub. No.: US 2012/0131595 A1
(43) Pub. Date: May 24, 2012

(54) PARALLEL COLLISION DETECTION METHOD USING LOAD BALANCING AND PARALLEL DISTANCE COMPUTATION METHOD USING LOAD BALANCING

(75) Inventors: Young Jun KIM, Seoul (KR); Young Eun Lee, Seoul (KR)

(73) Assignee: EWHA UNIVERSITY-INDUSTRY COLLABORATION FOUNDATION, Seoul (KR)

(21) Appl. No.: 13/114,137

(22) Filed: May 24, 2011

(30) Foreign Application Priority Data
Nov. 23, 2010 (KR) 10-2010-0116600

(51) Int. Cl. G06F 9/46

(52) U.S. Cl. 718/105

(57) ABSTRACT

Disclosed herein is a parallel collision detection method using load balancing in order to detect collision between two objects of a polygon soup. The parallel collision detection method is processed in parallel using a plurality of threads. The parallel collision detection method includes traversing a Bounding Volume Traversal Tree (BVTT) using Bounding Volume Hierarchies (BVHs) related to the polygon soup in a depth first search manner or a width first search manner; recursively traversing the children node of an internal node (a parent node) when a currently traversed node is the internal node and two Boundary Volumes (BVs) in the corresponding node overlap, and stopping to traverse the node when the currently traversed node is the internal node and two Boundary Volumes (BVs) do not overlap; and storing collision primitives in a leaf node when the currently traversed node is the leaf node and collision primitives in the leaf node overlap.

### CROSS-REFERENCE TO RELATED APPLICATION

This application claims priority to and the benefit of Korean Patent Application No. 10-2010-0116600 filed in the Korean Intellectual Property Office on Nov. 23, 2010, the entire contents of which are incorporated herein by reference.

### BACKGROUND OF THE INVENTION

1. Field of the Invention

The present invention relates generally to a parallel collision detection method and a parallel distance computation method, and, more particularly, to a parallel collision detection method using load balancing and a parallel distance computation method using load balancing, which are used for virtual reality systems, such as physically-based simulations and haptics.

2. Description of the Related Art

In 1965, Dr. Gordon Moore of International Business Machines Corporation (IBM) presented Moore's law in which the number of transistors that can be placed on a semiconductor doubles every 18 months. Moore's law has continued to hold true for the last 40 years. However, recently, it has been difficult to geometrically increase the speed any more due to physical real world restrictions, such as clock speed and heat generation. In order to solve such physical limits and in order to enable the performance of a Personal Computer (PC) to conform with Moore's law as ever, multi-cored Central Processing Units (CPUs) have recently appeared.

Multi-core means a processor which has two or more cores in hardware manner.

FIG. 1 is a conceptual diagram illustrating the task model of a multi-core processor. As shown in the drawing, when multi cores are used, the respective cores can simultaneously perform tasks in a parallel manner in such a way as to divide a single program.

As described above, simultaneous processing of the processes in a program is called parallel programming. Further, a basic unit in which operations are processed in parallel in parallel programming is called a thread. Since parallel programming enables tasks to be simultaneously performed, tasks can be performed faster than in sequential programming, therefore parallel programming is used in various fields, such as databases, medical imaging, and economics.

Speedup s(p) based on the use of p threads may be expressed as the following Equation:

$$S ( p ) = \frac{{t}_{1}}{{t}_{p}} \qquad ( 1 )$$

where t₁ is the measured time or the number of operations when one thread is used, and tₚ is the measured time or the number of operations when p threads are used. Generally, since tₚ is equal to or larger than t₁/p, S(p)≦p. However, occasionally, the case where S(p)>p may occur. Such a case is called super linear speedup. The super linear speedup may occur when a caching hit ratio increases because main memory is shared or when a solution is approached fast in the process of dividing an algorithm and performing the resulting algorithm.

However, there is a limit on the speedup which can be obtained by increasing the number of threads as described above. According to Amdahl's law, the maximum speedup which can be obtained in parallel programming is given by the following Equation:

$$S ( p ) = \frac{{t}_{1}}{{rt}_{1} + ( 1 - r ) {t}_{1} / p} \qquad ( 2 )$$

where r is a ratio of sections which should be sequentially processed to the entire program, and (1−r) is a ratio of sections which can be processed in parallel to the entire program. Equation 2 represents the maximum speedup which can be obtained in parallel programming. However, in actual parallel programming, there is a limit to obtain the result value of Equation 2 as it is because of overhead attributable to race condition, data transmission, and parallel processing.

Flynn's taxonomy is the most widely-used method of performing classification on parallel programming. FIG. 2 is a conceptual diagram illustrating Flynn's taxonomy. As shown in the drawing, Flynn's taxonomy divides instructions and data, which are processed by cores, into four types, that is, Single Instruction, Single Data (SISD), Multiple Instruction, Single Data (MISD), Single Instruction, Multiple Data (SIMD), and Multiple Instruction, Multiple Data (MIMD).

In particular, a Graphic Processing Unit (GPU) is classified as an SIMD structure according to Flynn's taxonomy. The SIMD structure means a way in which a number of threads are controlled using a single control unit and all threads process different data using the same instruction. Meanwhile, a multi-core CPU operates in an MIMD structure in which a number of threads process different data using instructions which are different from each other.

Such a GPU is hardware which has been especially designed in order to process computer graphics, and, recently, has showed startling speedup. In particular, a General Purpose computing on GPU (GPGPU) in which a GPU can be used for the purpose of general operations has been developed and optimized to perform parallel programming.

However, although a GPU can perform faster operation processing than a CPU, a GPU has a problem of relatively long data transmission time. Further, since a GPU has an SIMD-based structure, threads cannot execute respective instructions which are different from each other. Therefore, generally, in the case of a program which includes a small amount of data and few operations, parallel programming using a CPU may obtain greater speedup.

Meanwhile, proximity query is used to find relative information about locations between two objects. The representative examples of the proximity query include collision detection, distance computation, and penetration depth.

Collision detection is used to find whether two objects overlap each other and to find overlapping sections when the two objects overlap. Distance computation is used to compute the Euclidean minimum distance between two objects.

Such proximity query is widely used in various application fields, such as games, computer animation, virtual reality, and haptics. In such application fields, in order to ensure a fast response time for a user and generate stable simulation, fast real-time proximity query computation for complicated polygonal models is important.

Recently, with the developments in hardware, such as multi-core and multi-processor, research to processing proximity query calculations in parallel has made progress. Such research has been confined and focused on the case of a large number of operations which are complicated, for example, Continuous Collision Detection (CCD) related to deformable models. For proximity query for rigid models, research into collision detection has partially made progress. However, the results of the research are disappointing.

Three reasons for the disappointment will be described. First, in the case of proximity query for rigid models, there is small number of operations to be performed, compared to proximity query for deformable models. When parallel processing is performed on a program which has a small number of operations, there is a problem in that overhead, generated in the process of performing locking or load balancing, increases, thereby increasing execution time. Second, almost all proximity query algorithms include frequent branches which occur in a computation process using Bounding Volume Hierarchies (BVHs), with the result that that accurate operation time cannot be estimated, so that there is a problem in that it is difficult to find an optimized load balancing algorithm in such situation. Finally, when an optimized algorithm, such as Robust and Accurate Polygon Interference Detection (RAPID) or Proximity Query Package (PQP), is used to compute proximity query between rigid models, the number of sections on which parallel processing can be performed is small, so that there is a problem in that it is difficult to obtain excellent speedup.

### SUMMARY OF THE INVENTION

Accordingly, the present invention has been made keeping in mind the above problems occurring in the prior art, and an object of the present invention is to provide a parallel collision detection method using load balancing, which obtains proximity query computation between rigid models formed of polygon soups using a CPU in parallel and in real time.

Another object of the present invention is to provide a parallel distance computation method using load balancing, which obtains proximity query computation between rigid models formed of polygon soups using a CPU in parallel and in real time.

In order to accomplish the above object, the present invention provides a parallel collision detection method using load balancing in order to detect collision between two objects of a polygon soup, the parallel collision detection method being processed in parallel using a plurality of threads, and the parallel collision detection method including: traversing a Bounding Volume Traversal Tree (BVTT) using Bounding Volume Hierarchies (BVHs) related to the polygon soup in a depth first search manner or a width first search manner; recursively traversing the children node of an internal node (a parent node) when a currently traversed node is the internal node and two Boundary Volumes (BVs) in the corresponding node overlap, and stopping to traverse a node when the currently traversed node is the internal node and two Boundary Volumes (BVs) do not overlap; and storing collision primitives in a leaf node when the currently traversed node is the leaf node and collision primitives in the leaf node overlap. Here, the parallel collision detection method further includes culling a corresponding node when the two objects of the polygon soup do not collide with each other.

The load balancing includes estimating the number of children nodes to be traversed, and equally distributing collision detection tasks to the respective threads; and the estimating includes determining the depth of the node using the penetration depth of the BVs. Here, when the relative value of the penetration depth of areas of the BVs is large, the parallel collision detection method includes determining the large number of children nodes to be traversed, and enqueuing a left children node. Here, the relative value of the penetration depth is determined using

$$\frac{ɛ D}{\sum \vert {r}_{a}^{i} D \vert + \sum \vert {r}_{b}^{i} D \vert} \geq α$$

where εD is the penetration depth between BVₐ and BV_{b}, ε is the shortest of differences between values obtained by projecting the centers and radiuses of sides of the given two overlapping BVₐ and BV_{b} in 15 different axes, D is an axis corresponding to ε, rₐⁱ and r_{b}ⁱ are vectors which represent the radiuses of the respective sides of the BVₐ and BV_{b}, and α is a value designated by a user.

Further, in the parallel collision detection method of the present invention, it is preferable that the left children node be traversed by threads other than a thread which traversed the parent node, and the thread which traversed the parent node recursively traverse a right side children node.

Meanwhile, the present invention provides a parallel distance computation method using load balancing in order to compute distance between two objects of a polygon soup, the parallel distance computation method being processed in parallel using a plurality of threads, and the parallel distance computation method including: traversing a BVTT using BVHs related to the polygon soup in a depth first search manner or a width first search manner; computing an Euclidean minimum distance between two BVs in a node when a currently traversed node is an internal node, recursively traversing the children nodes of the internal node (parent node) when the Euclidean minimum distance is smaller than a predetermined upper bound, and stopping to traverse the node when the currently traversed node is the internal node and the computed Euclidean minimum distance of the two BVs in the node is equal to or larger than the predetermined upper bound; and computing the distance between the two objects of the polygon soup in a leaf node when the currently traversed node is the leaf node, and updating the predetermined upper bound using the computed distance when the computed distance is smaller than the predetermined upper bound.

Here, the load balancing includes estimating the number of children nodes to be traversed, and equally distributing distance computation tasks to the respective threads; and the estimating includes computing the estimation value of d(A,B) (d(·) is an operation used to obtain the Euclidean minimum distance, A and B are the two objects of the polygon soup) which has a predetermined weight, determining that any one of children nodes of a node {a,b} corresponds to the Euclidean minimum distance when the Euclidean minimum distance d(a,b) of the node {a,b} is smaller than the estimation value, and pushing a left children node to a stack. The estimation value is obtained using

Evaluation value=ωd(a₀,b₀)+(1−ω)σ

where {a₀,b₀} is the root node of the BVTT, ω is the predetermined weight, and σ is the predetermined upper bound.

### BRIEF DESCRIPTION OF THE DRAWINGS

The above and other objects and advantages as well as features of the present invention will be more clearly understood from the following detailed description taken in conjunction with the accompanying drawings, in which:

FIG. 1 is a conceptual diagram illustrating the task model of a multi-core thread;

FIG. 2 is a conceptual view illustrating Flynn's taxonomy;

FIG. 3 is a conceptual view illustrating an embodiment of load balancing used in the parallel processing of the present invention;

FIG. 4 is a conceptual view illustrating an embodiment of dynamic load balancing using a work pool;

FIG. 5 is a conceptual view illustrating an embodiment of BVHs and a BVTT according to an embodiment;

FIGS. 6A to 6C are conceptual views illustrating embodiments of collision types between OBBs;

FIGS. 7A to 7B are views illustrating an embodiment in which the traversal pattern of a BVTT in collision detection is compared with the traversal pattern of a BVTT in distance computation of the present invention;

FIG. 8 is a view illustrating an embodiment of an SSV used for distance computation of the present invention;

FIG. 9 is a conceptual view illustrating the upper bound and lower bound of the minimum distance between the SSVs of the present invention;

FIG. 10 is a view illustrating an embodiment of models used for benchmarking of the present invention;

FIGS. 11A to 11C are views illustrating a first case to a third case for collision detection of a (bunny 1 and bunny 2) polygon soup of the present invention;

FIGS. 12A to 12C are views illustrating a first case to a third case for collision detection of a (club and gear) polygon soup of the present invention;

FIGS. 13A to 13C are views illustrating a first case to a third case for collision detection of a (watch 1 and watch 2) polygon soup of the present invention;

FIG. 14 is a graph illustrating an embodiment of a collision detection execution time (the number of frames/second) depending on the number of threads of the present invention.

FIG. 15 is a graph illustrating an embodiment of an improvement ratio of an execution time in the case of one thread to the collision detection execution time of the present invention;

FIGS. 16A to 16C are views illustrating a fourth case to a sixth case of the distance computation of the (bunny 1, bunny 2) polygon soup of the present invention;

FIGS. 17A to 17C are views illustrating a fourth case to a sixth case of the distance computation of the (club, gear) polygon soup of the present invention;

FIGS. 18A to 18C are views illustrating a fourth case to a sixth case of the distance computation of the (watch 1, watch 2) polygon soup of the present invention;

FIG. 19 is a graph illustrating an embodiment of a distance computation execution time (the number of frames/second) depending on the number of threads of the present invention;

FIG. 20 is a graph illustrating an embodiment of an improvement ratio of an execution time in the case of one thread to the distance computation execution time of the present invention;

FIG. 21 is a view illustrating an example of super linear speedup; and

FIG. 22 is a graph illustrating an embodiment of change in the number of nodes to be traversed depending on the number of threads according to a distance computation method of the present invention.

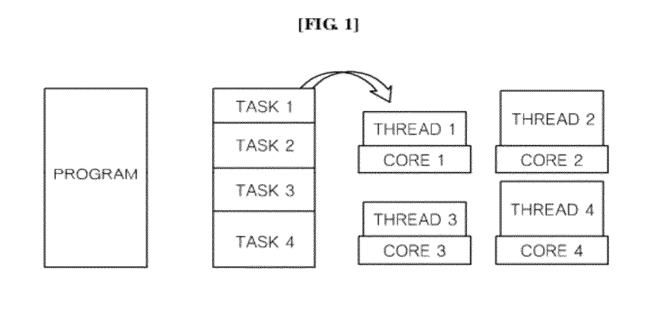

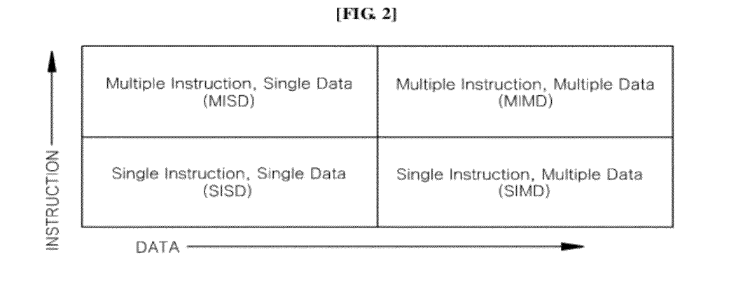

### DESCRIPTION OF THE PREFERRED EMBODIMENTS

Hereinafter, embodiments of the present invention will be described in detail with reference to the attached drawings.

In the description of the present invention, load balancing used for parallel processing of the present invention and parallel proximity query will be described first, and then a parallel collision detection method and a parallel distance computation method will be described.

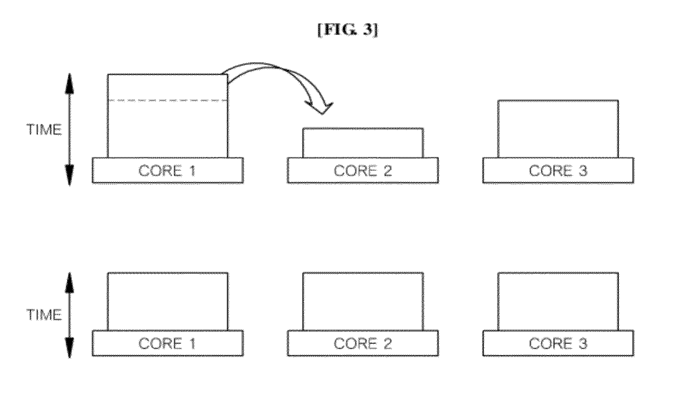

When parallel programming is designed, a load balancing method, which meets both the concurrency of threads and dependency between instructions, thereby obtaining maximum speedup, should be considered. FIG. 3 is a conceptual view illustrating load balancing for parallel processing of the present invention. As shown in the drawing, it can be seen that the execution time is reduced by load balancing.

A load balancing method includes a static method of previously estimating an execution time and then performing distribution before a program runs, and a dynamic method of performing distribution when a program is running. Generally, it is difficult to estimate the exact execution times of distributed tasks using the static load balancing method, so that the dynamic load balancing method is mainly used.

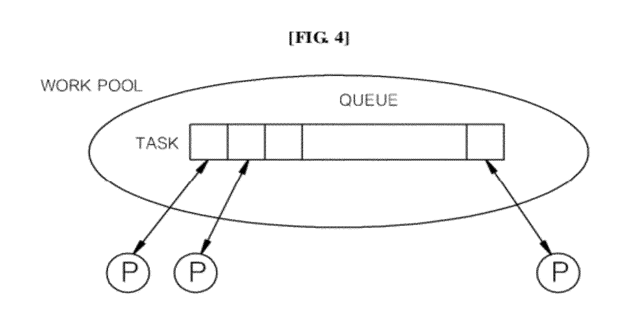

A work pool is a place where divided tasks are collected, and is a technique used in dynamic load balancing. FIG. 4 is a conceptual view illustrating an embodiment of dynamic load balancing using a work pool. As shown in the drawing, when threads P request tasks from a work pool, tasks can be dynamically distributed. Here, a stack or a heap can be used as a work pool in addition to a queue. Here, a queue is a structure in which data which comes in first goes out first, and a stack is a structure in which data which comes in first goes out last.

The load balancing method using a work pool is applied to branch and bound which is a classic searching technique. Branch and bound means searching a state space tree. When a state space tree is searched, nodes are traversed from a root node to children nodes. Here, a problem is solved in such a way as not to traverse all nodes but to cull nodes and traverse only a part of the nodes of a tree, those which meet a condition. The feature of a state space tree is that nodes to be traversed cannot be estimated before search is performed, unlike other search trees. An example of the state space tree includes a BVH and a Bounding Volume Traversal Tree (BVTT).

When a state space tree is searched in parallel using the single queue of a central work pool, maximum speedup can be obtained as following Equation:

$$S ( n ) \leq \frac{{t}_{access} + {t}_{comp}}{{t}_{access}} = 1 + \frac{{t}_{comp}}{{t}_{access}} \qquad ( 3 )$$

where n is the greatest degree of a state space tree, t_{access} is the average time that a queue is accessed, t_{comp} is the average operation time of each node. In Equation 3, it can be seen that speedup increases as the operation time becomes longer and the time that a queue is accessed becomes shorter for each node.

When threads which are different from each other simultaneously access a work pool, an erroneous operation may occur. Further, overhead attributable to parallel processing is generated in a lock process performed such that only one thread may access a work pool in order to prevent the competition between threads. Work stealing was introduced in order to solve such a problem, that is, competition between threads. Work stealing enables a thread which has finished a task to fetch and perform a task of another thread. If a work stealing method is used, the waste of threads attributable to locking can be reduced.

Meanwhile, parallel proximity query will be described below.

Since collision detection between rigid models includes a small number of operations and requires a different type of control for each thread, parallel processing using a CPU is performed in most research. Since collision detection can be realized fast when BVHs are used, research using BVHs has made progress in parallel collision detection. Huagen et al proposed an algorithm for searching a hybrid BVH, in which a sphere and an Axis-Aligned Bounding Box (AABB) are mixed, using parallel programming, and obtained a 2.5 times-improved speedup when 4 CPUs are used, compared to sequential programming. Zhao et al performed parallel processing on collision detection using a hybrid BVH but speedup degraded after the number of threads exceeded 4.

Unlike rigid models, deformable models require self-collision detection as well as separate BVH update during collision detection. As the number of operations is large and operations are complicated, the operations are suitable to parallel processing, so that a large number of collision detection researches are concentrated on deformable models, and the results thereof are more satisfactory than those of rigid models. Tang et al realized Continuous Collision Detection (CCD) using priority depending on collision possibility, and improved performance by a maximum of 13 times using a 16-core CPU. Kim et al. used a method of updating BVHs using a CPU and calculating CCD using a GPU, thereby achieving linear speedup depending on the number of threads.

A BVH is a data structure which is applied to the computation of proximity query. In the case of a deformable model, BVHs should be frequently updated. Therefore, if BVHs are built using parallel processing, the performance thereof may be improved. Wald proposed a method of processing operations of building BVHs in parallel for respective intervals as ray tracing research. Ize et al proposed a method of asynchronously rebuilding BVHs in the case of rendering. Lauterbach et al proposed a method of building BVHs based on a GPU.

After discussing a general collision detection method, a parallel collision detection method using load balancing of the present invention will be described below.

Since a Bounding Volume (BV) has a geometric shape which is much simpler than that of an inclusion model, proximity query computation using BVs is much faster than computation using its own model. A representative BV includes a sphere, an Oriented Bounding Box (OBB), an Axis-Aligned Bounding Box (AABB), and a Swept Sphere Volume (SSV).

A BVH is a tree structure which includes a BV as a node. The root node of the BVH is the BV of the entire model, and a leaf node includes the collision primitive of the model. Further, children node is the BV of a resulting model into which the model included in a parent node is divided. Proximity query can be obtained fast in such a way that BVHs are sequentially traversed from a root node to leaf nodes.

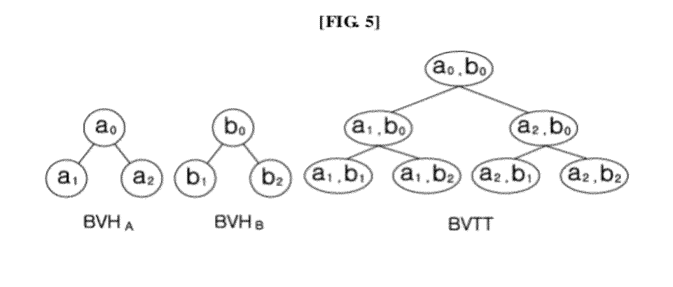

A Bounding Volume Traversal Tree (BVTT) is a tree which represents status used to recursively obtain proximity query using two BVHs, and each node of the BVTT corresponds to a pair of nodes of BVHs which are different from each other. FIG. 5 is a conceptual view illustrating an embodiment of BVHs and a BVTT. As shown in the drawing, for example, it is assumed that there are BVH_{A} and BVH_{B} which are BVHs for respective models A and B. In this case, the root node of the BVTT corresponds to {aₒ,bₒ} which is the pair of the root nodes of the respective BVH_{A} and BVH_{B}. The left children node of the {aₒ,bₒ} becomes {a₁,bₒ} in such a way that a₁ which is the left child node of aₒ is substituted for aₒ.

The reason for this is that the proximity query should be performed in such a way as to traverse {a₁,bₒ} after {aₒ,bₒ} is traversed. When the above method is applied again, the right child node of the {aₒ,bₒ} may be defined as {a₂,bₒ}. Obtaining proximity query is the same as the traversal of the BVTT tree. Such a BVTT is made in a dynamic manner at the time that proximity query is performed. Here, since the shape of a BVTT to be traversed changes depending on a culling method, it is difficult to previously estimate the shape of a BVTT to be generated.

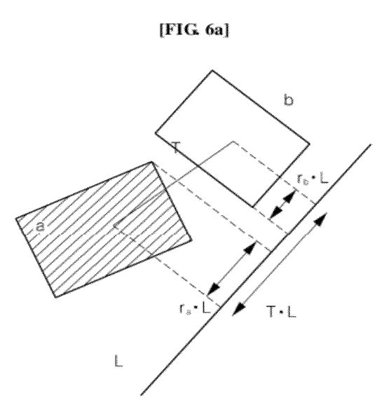

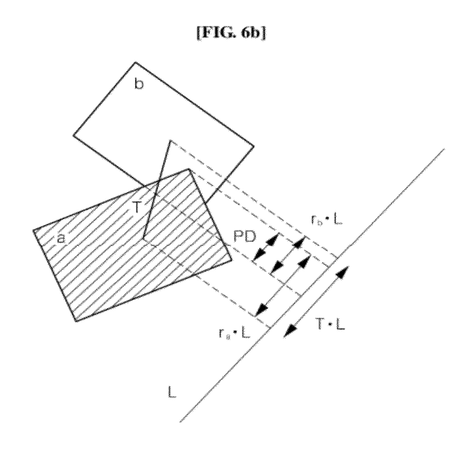

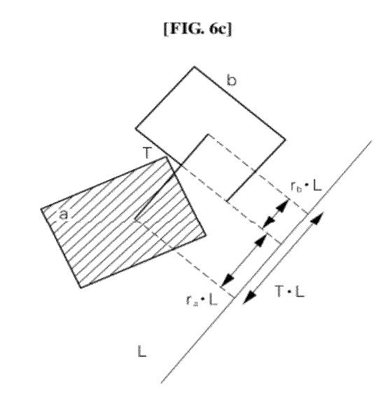

Meanwhile, an OBB is a BV which is frequently used for collision detection. The collision detection between OBBs can be easily obtained using a separating axis theorem. If there is at least one axis which does not overlap when two objects are projected, the two objects will not have collided. FIGS. 6A to 6C are conceptual views illustrating embodiments of collision types between OBBs, FIG. 6A illustrates separation status, FIG. 6B illustrates overlapping status, and FIG. 6C illustrates contact status. According to a collision detection method, two OBBs a and b will not have collided if there is a separating axis L which meets the following Equation:

$$\vert T L \vert > {\sum }_{i} \vert {r}_{a}^{i} L \vert + {\sum }_{i} \vert {r}_{b}^{i} L \vert \qquad ( 4 )$$

where rₐⁱ and r_{b}ⁱ are vectors which represent the radiuses of the respective sides of the OBBs a and b, and T is a vector which connects the center points of a and b. According to the separating axis theorem, if any one of 15 Ls (three planes of a, three planes of b, and 9 pairs of edges of a and b) meets Equation 4, A and B will not have overlapped.

The penetration depth of two overlapping objects means the minimum translation used to separate the two objects. In particular, in the case of a generalized model (a non-convex model), it is very difficult and complex to obtain the penetration depth. If two OBBs, that is, a and b, have overlapped, all the 15 axes meet Σ|rₐⁱL|+Σ|r_{b}ⁱL|−|TL|>0. This is shown in FIG. 6B. It is assumed that D is one of the 15 axes, which meets the following Equation:

ε=arg_{L}min(Σ|rₐⁱL|+Σ|r_{b}ⁱL|−|TL|>0 (5)

where εD is the penetration depth between a and b, and is defined as follows:

If it is assumed that ε is the shortest of differences between values obtained by projecting the centers and radiuses of sides of the given overlapping OBBs a and b in 15 different axes and D is an axis corresponding to ε, εD is the penetration depth between a and b.

A parallel collision detection method using load balancing will be described below. A collision detection device in which the present invention is realized is preferably a CPU.

The parallel collision detection method of the present invention obtains proximity query using BVHs. Proximity query using BVHs is the same as the dynamic traversal of a BVTT. A method of traversing a BVTT includes depth first search and breadth first search. In this case, when the nodes of the BVTT are traversed, the search method may vary depending whether nodes are leaf nodes or internal nodes. That is, in the case of an internal node, it is checked whether two BVs have overlapped in a node using Equation 4. When the BVs have overlapped, a children node is recursively traversed or enqueued. Otherwise, no more children nodes are traversed. Meanwhile, in the case of a leaf node, it is checked whether collision primitives in the leaf node have overlapped. If two collision primitives have overlapped, the collision primitives of the leaf node are stored.

When a BVTT is searched, only nodes in which BVs have overlapped are traversed, so that the shape of the BVTT to be traversed varies each time. Therefore, the BVTT becomes a state space tree in parallel programming. In the collision detection method of the present invention, load balancing is performed using a work pool queue in order to traverse the BVTT in parallel. The collision detection method of the present invention includes a little additional computation, so that overhead can be minimized in the process of parallel programming.

The important point of load balancing is to previously estimate task execution time and to equally distribute the task execution time to each thread. In other words, when the task of the node {a, b} of BVTT is executed, it is preferable to estimate the number of children nodes to be recursively traversed. As a and b are deeply overlapped, the probability that the collision primitives, included in a and b, are overlapped is high, so that the probability that the children nodes will be traversed is also high. How deeply the node {a, b} has overlapped can be seen using the penetration depth between a and b. The following Equation is used to estimate the penetration depth of the node of BVTT.

$$\frac{ɛ D}{\sum \vert {r}_{a}^{i} D \vert + \sum \vert {r}_{b}^{i} D \vert} \geq α \qquad ( 6 )$$

where α is a value which should be determined by a user, and, preferably, may be set to 0.8. Unlike Equation 5, Equation 6 represents a relative value of the penetration depth related to the areas of a and b. If a penetration depth value is large compared to the areas of a and b, the number of children nodes to be traversed is large, so that a left children node is enqueued (data is inserted into a queue). Another thread traverses an enqueued left children node, and a thread which traversed a parent node recursively traverses a right children node.

A parallel distance computation method using load balancing according to the present invention will be described below. A distance computation device on which the present invention is performed is preferably a CPU as described above.

In the distance computation method of the present invention, the generation method and structure of a BVTT are the same as those of the collision detection method but a BVTT traversal method is different from that of the collision detection method. Although the collision detection method of the present invention allows culling to be performed using Equation 4, the distance computation method allows culling to be performed using an upper bound σ.

That is, with regard to internal nodes, the Euclidean minimum distance between two BVs of a node is computed, and, if the Euclidean minimum distance is smaller than σ, children nodes are recursively traversed or pushed. Otherwise, no more children nodes are traversed. With regard to leaf nodes, the distance between the models of a leaf node is computed. If the calculated distance is smaller than σ, σ is updated using the computed distance.

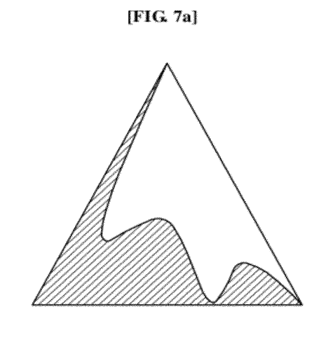

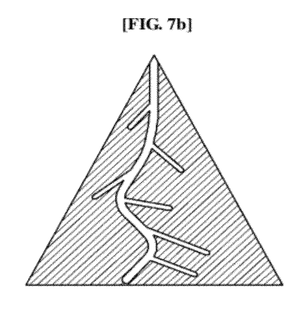

FIGS. 7A to 7B are views illustrating an embodiment in which the traversal pattern of a BVTT in collision detection is compared with the traversal pattern of a BVTT in distance computation of the present invention. An oblique line section represents the entire shape of the BVTT, and a white color section represents nodes which were traversed in the process of proximity query computation.

According to the collision detection method of the present invention, all the BVTT nodes which are detected as a collision should be traversed. However, the purpose of the distance computation method is to find a primitive which has a minimum distance and to fast update σ, so that far more BVTT nodes may be culled, compared to the collision detection method. That is, as shown in FIG. 7B, a larger number of nodes are culled in distance computation. Therefore, since the amount of computation should be small and the access of other threads should be blocked when σ is being updated, it is generally more difficult to process distance computation in parallel than to process collision detection in parallel.

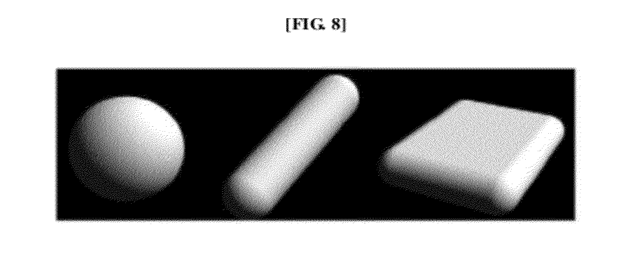

In the present invention, an SSV is used as a BV used for distance computation. The SSV may be represented using the Minkowski sum of a sphere having a given radius and a reference figure. The SSV is divided into three types based on the reference polygon. First is a Point Swept Sphere (PSS), which is based on a dot and has a shape like a sphere. Second is a Line Swept Sphere (LSS), which is based on a line and has a shape like a capsule. Third is a Rectangular Swept Sphere (RSS), which is based on a rectangle. FIG. 8 is a view illustrating an embodiment of the SSV which is used for distance computation of the present invention, and shows the PSS, the LSS, and the RSS from the left.

The SSV can be effectively used to obtain proximity query. In particular, distance computation can be easily obtained in such a way that the radius of a given sphere is subtracted from the distance between polygons (dots, lines, or rectangles) which form the basis of the SSV.

A parallel distance computation method of the present invention is similar to the above-described parallel collision detection method. However, different conditions are used for load balancing. In the distance computation method of the present invention, σ should be fast updated, thereby culling a large number of nodes. In particular, since leaf nodes should be approached in order to update σ, a stack is used instead of a queue. As described above, a queue has a structure in which data which comes in first goes out first, and a stack has a structure in which data which comes in first goes out last. The reason for using a stack is that the high level node of a BVTT is popped first (data popped out from a stack) when a stack is used, thereby enabling depth first search.

While load balancing used in the collision detection method of the present invention focuses on the conditions of enqueueing data into a queue (inserting data into a queue), load balancing used in the distance computation method focuses on a method of pushing data onto a stack (inserting data onto a stack). Push conditions for the BVTT node {a,b} in sets A and Bis like the following Equation 7.

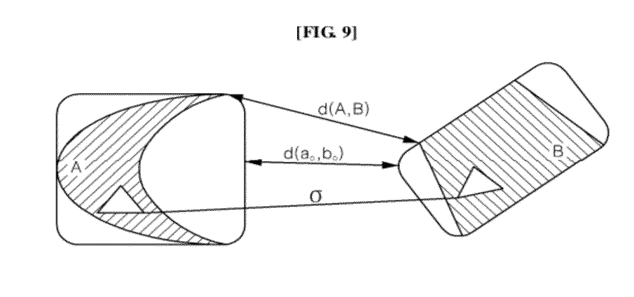

d(a,b)<ωd(a₀,b₀)+(1−ω)σ (7)

where d(·) is an operation used to obtain Euclidean minimum distance, and {aₒ,bₒ} is the root node of the BVTT. σ is a culling condition for the BVTT nodes and is the estimated value of d(A,B). FIG. 9 is a conceptual view illustrating an embodiment of the upper bound and lower bound of the minimum distance between SSVs of the present invention. As shown in the drawing, it can be seen that d(aₒ,bₒ) and σ correspond to the upper bound and the lower bound of d(A,B), respectively. That is, d(a₀,b₀)≦d(A,B)≦σ.

In above Equation 7, ωd(a₀,b₀)+(1−ω)σ is the estimated value of d(A,B) which has a weight σ. If d(a,b) is smaller than the estimated value, it is assumed that there is a model which realizes Euclidean minimum distance from among the children nodes of the node {a,b}, so that a left children node is pushed onto a stack. In an embodiment of the present invention, ω is set to 0.9. The reason for this is that σ is initially a distance related to an arbitrary reference polygon, so that d(aₒ,bₒ) is estimated to be closer to d(A,B) than 6.

### Embodiment

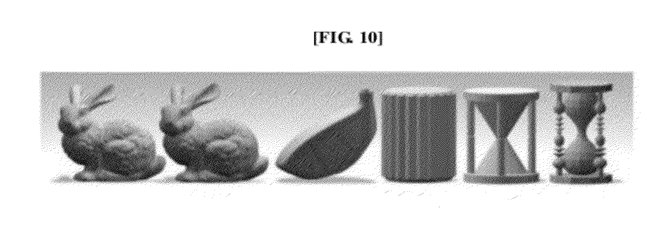

The present invention has implemented collision detection and distance computation for rigid models in parallel using a CPU. FIG. 10 is a view illustrating an embodiment of models used for benchmarking the present invention. For the experiment of the present invention, collision detection and distance computation are performed on 9 cases using polygon models of (bunny 1 and bunny 2), (club and gear), and (watch 1 and watch 2), which are arranged from the left of FIG. 10.

First, an embodiment related to collision detection will be described below.

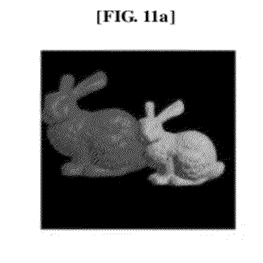

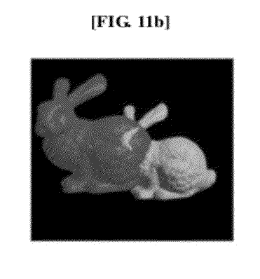

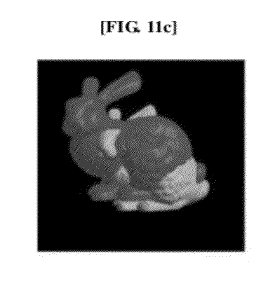

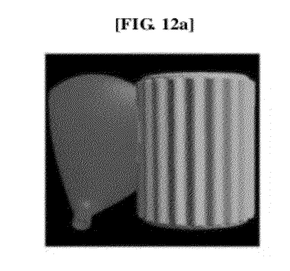

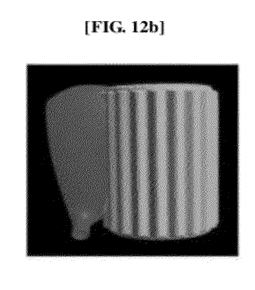

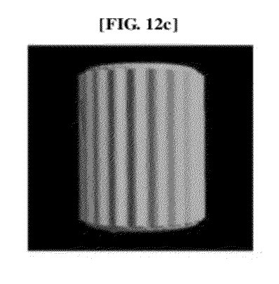

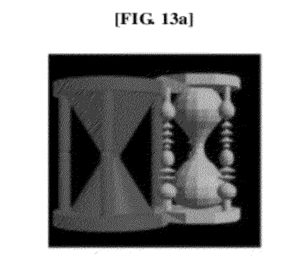

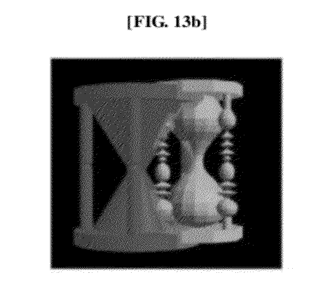

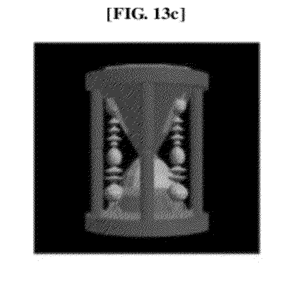

As an embodiment of the present invention, the average collision detection time is obtained by measuring the collision detection time of each frame in such a way that two objects of a polygon soup are overlapped by substantially ¼ (first case), ½ (second case) and 1 (third case), and one rigid model is rotated 72 times by 5° centering on a y axis (rotated total 360°). α of Equation 6 is set to 0.8. FIGS. 11A to 11C show the first case to third case of the collision detection of the present invention related to the (bunny 1, bunny 2) polygon soup, FIGS. 12A to 12C show the first case to third case of the collision detection of the present invention related to the (club, gear) polygon soup, and FIGS. 13A to 13B show the first case to third case of the collision detection of the present invention related to the (watch 1, watch 2) polygon soup. In the drawings, the green color objects in the right side are rotated, and the red portions of the drawings represent overlapped collision primitives.

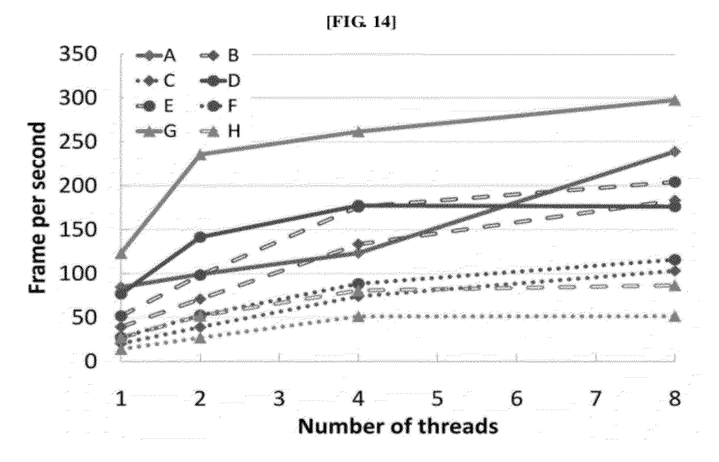

FIG. 14 is a graph illustrating an embodiment of a collision detection execution time (the number of frames/second) of the present invention based on the number of threads. In FIG. 14, A represents a graph related to FIG. 11A, B represents a graph related to FIG. 11B, C represents a graph related to FIG. 11C, D represents a graph related to FIG. 12A, E represents a graph related to FIG. 12B, F represents a graph related to FIG. 12C, G represents a graph related to FIG. 13A, H represents a graph related to FIG. 13B, and I represents a graph related to FIG. 13C, respectively.

As shown in the drawings, it can be seen that an execution time becomes fast as the number of threads increases. Further, the first case (A, D, or G) in which the number of overlapping collision primitives is relatively small is faster than the third case (C, F, or I) in which overlapping collision primitives are relatively larger.

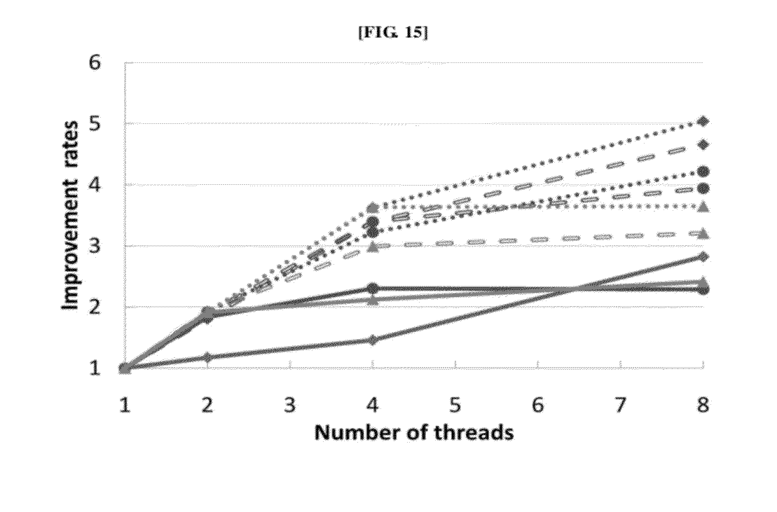

FIG. 15 is a graph illustrating an embodiment of an improvement ratio of an execution time in the case of one thread to a collision detection execution time of the present invention. As shown in the drawing, speedup normally improves as the number of threads increases. Further, it can be seen that the performance of the third case (C, F, or I) in which the number of overlapping collision primitives is large is improved more, compared to other cases. The reason for this is that the number of sections on which parallel processing can be performed increase as the scenario which includes a large number of overlapping collision primitives and a large number of operations.

Meanwhile, an embodiment related to the distance computation of the present invention will be described below.

In the embodiment of the present invention, Euclidean minimum distance between two objects of a polygon soup is set to approximately 0 to 1 (fourth case), 1 to 3 (fifth case), and 3 to 5 (sixth case), and an average distance computation time is obtained in such a way as to rotate one polygon soup 72 times by 5′ and measure the distance computation time of each frame. The (bunny 1, bunny 2) polygon soup is rotated around a z axis, and the (club, gear) and (watch 1, watch 2) polygon soups are rotated around an x axis. If the (bunny 1, bunny 2) polygon soup is rotated around the x axis, the minimum distance is the same at every rotation, so that the rotation axis is changed to the z axis in order to measure the exact performance. ω of Equation 7 is set to 0.9.

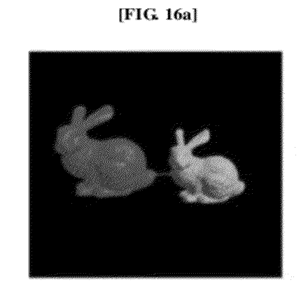

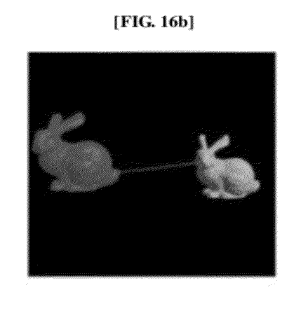

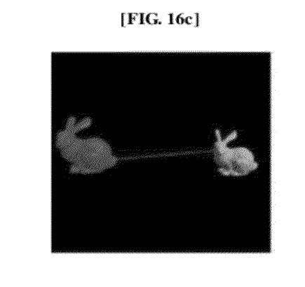

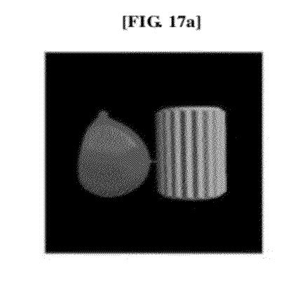

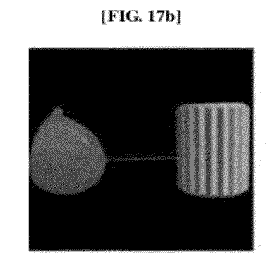

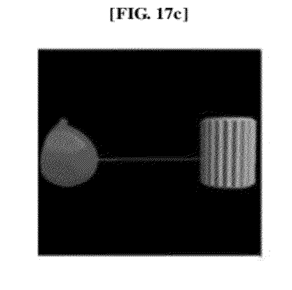

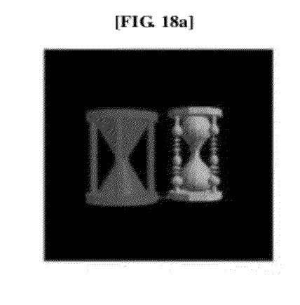

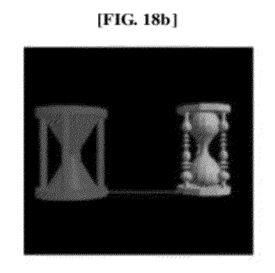

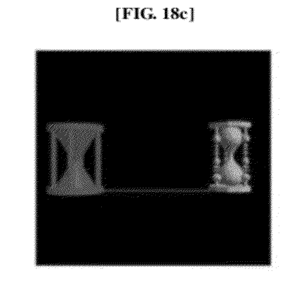

FIGS. 16A to 16C illustrates the fourth case to the sixth case of the distance computation of the (bunny 1, bunny 2) polygon soup of the present invention. FIGS. 17A to 17C illustrates the fourth case to the sixth case of the distance computation of the (club, gear) polygon soup of the present invention. FIGS. 18A to 18C illustrates the fourth case to the sixth case of the distance computation of the (watch 1, watch 2) polygon soup of the present invention. The green color objects in the right side of the drawings are rotated, and the red lines of the drawings represent the Euclidean minimum distance between two objects.

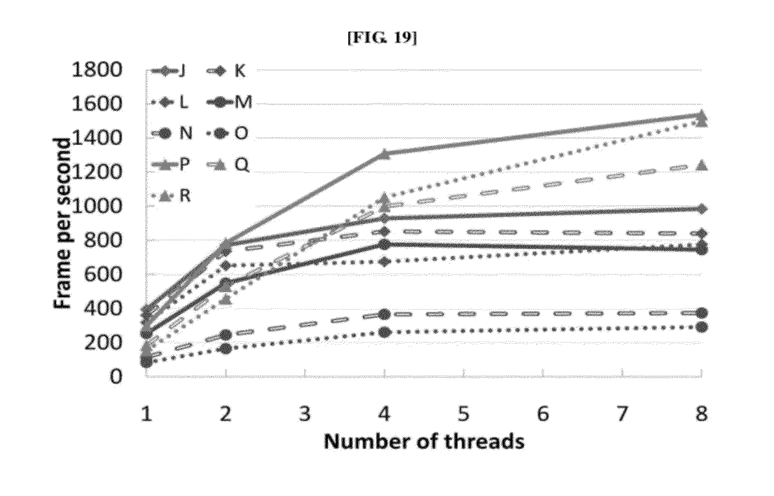

FIG. 19 is a graph illustrating an embodiment of a distance computation execution time (the number of frames/second) depending on the number of threads of the present invention. In FIG. 19, J represents a graph related to FIG. 16A, K represents a graph related to FIG. 16B, L represents a graph related to FIG. 16C, M represents a graph related to FIG. 17A, N represents a graph related to FIG. 17B, O represents a graph related to FIG. 17C, P represents a graph related to FIG. 18A, Q represents a graph related to FIG. 18B, R represents a graph related to FIG. 18C, respectively. As shown in the drawings, it can be seen that, generally, the execution time becomes fast as the number of threads becomes larger.

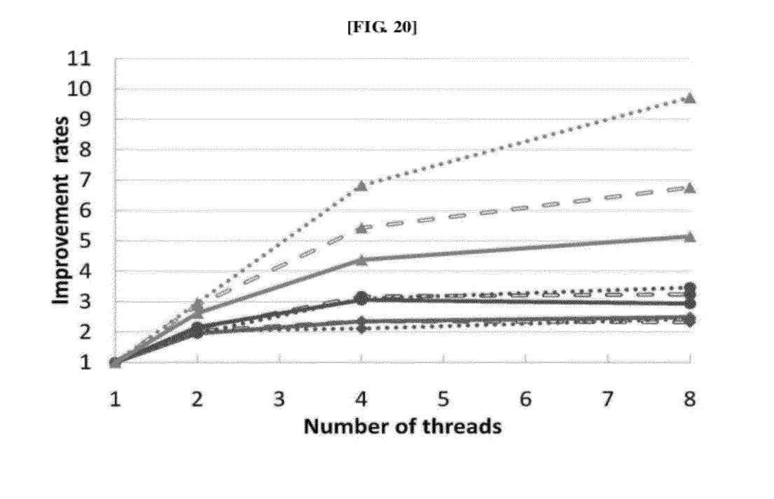

FIG. 20 is a graph illustrating an embodiment of an improvement ratio of an execution time when one thread is used to the distance computation execution time of the present invention.

As shown in the drawing, generally, as the number of threads increases, the speed of the distance computation is improved. A maximum speedup of 9.7 times is shown when the number of threads is 8.

In distance computation, the culling of the BVTT nodes is determined based on σ. As the difference between the initial value of σ and Euclidean minimum distance is large, a larger number of nodes are traversed, so that sections in which parallel processing can be performed increase. Therefore, the difference between the initial value of σ and Euclidean minimum distance functions as a factor which improves performance in parallel programming. Referring to FIG. 20, it can be seen that lines which have the same initial value of σ, that is, which have the same color, show similar speedup.

It can be seen that collision detection of the present invention realized a speedup of 2.2 to 5.0 times, which is stable, while the distance computation realized a speedup of 2.3 to 9.7 times, which has a wide speedup width. The reason for this is that the number of variables (σ and ω) in the distance computation is larger than the number of variables (α) in collision detection. Therefore, in the parallel distance computation method, super linear speedup can be realized depending on the setting of σ and ω, as shown in the case of R of FIG. 19.

That is, with regard to the graph of R of FIG. 19, it can be seen that a speedup of 8 times or more is shown when the number of threads is 8, compared to when the number of threads is 1. As described above, the case where speedup exceeds the number of threads is called super linear speedup.

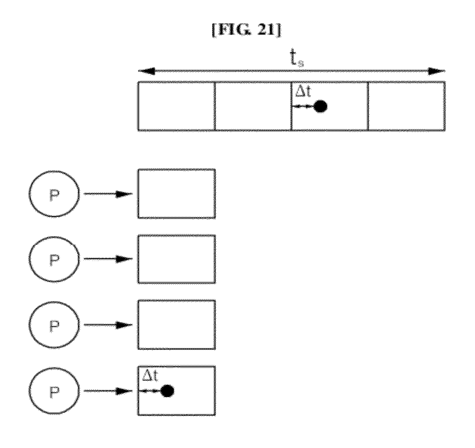

The super linear speedup is mainly generated when a cashing hit ratio increase due to the share of main memory or when a solution is fast approached in a process of dividing an algorithm and then processing the resulting algorithms. FIG. 21 shows an example of super linear speedup. As shown in the drawing, if it is assumed that the goal is to find a red dot, an execution time in the case of sequential search is

$$\frac{2 {t}_{s}}{p} + Δ t .$$

However, when 4 threads are used, the red dot can be found within Δt.

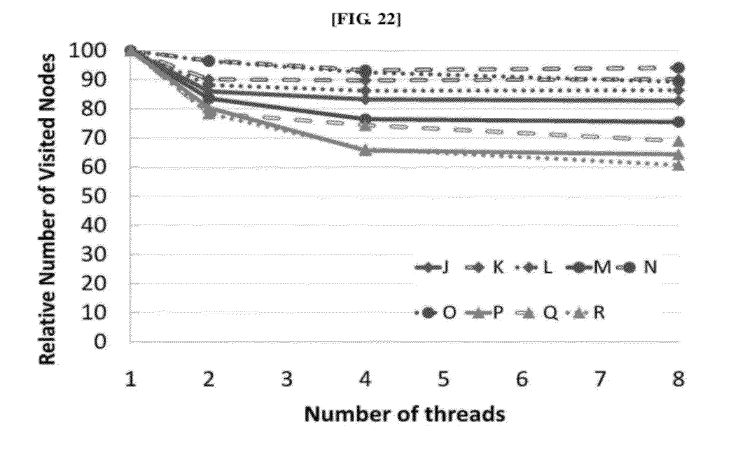

Another reason that super linear speedup appears in the distance computation of the present invention is that the BVTT is a state space tree. FIG. 22 is a graph illustrating an embodiment of the change in the number of nodes to be traversed depending on the number of threads according to the distance computation method of the present invention.

As shown in the drawing, in the case of R, that is, when Euclidean minimum distance is set to from 3 to 5 in the (watch 1, watch 2) polygon soup, it can be seen that, if it is assumed that the number of traversed nodes is 100 when only 1 thread is used, Euclidean minimum distance can be obtained by traversing only 60 nodes when 8 threads are used. Like this, if the number of threads increases, σ is fast updated, so that a large number of nodes are culled, thereby reducing the number of operations to be performed. That is, since the amount of task performed when one thread is used is different from the amount of task performed when eight threads are used, super linear speedup may appear.

As described above, the present invention does not compute a proximity query using complex operations but performs load balancing on a BVTT using a simple penetration depth operation and the sum of weights of the upper bound and lower bound, so that there is an advantage in that collision detection and distance computation can be processed in parallel at high speed.

Further, the present invention has an advantage in that the penetration depth between OBBs can be simply computed using a separating axis theorem.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A parallel collision detection method using load balancing in order to detect collision between two objects of a polygon soup, the parallel collision detection method being processed in parallel using a plurality of threads, and the parallel collision detection method comprising:
traversing a Bounding Volume Traversal Tree (BVTT) using Bounding Volume Hierarchies (BVHs) related to the polygon soup in a depth first search manner or a width first search manner;
recursively traversing a children node of an internal node (a parent node) when a currently traversed node is the internal node and two Boundary Volumes (BVs) in the corresponding node overlap, and stopping to traverse a node when the currently traversed node is the internal node and two Boundary Volumes (BVs) do not overlap; and
storing collision primitives in a leaf node when the currently traversed node is the leaf node and collision primitives in the leaf node overlap.

2. The parallel collision detection method as set forth in claim 1, further comprising culling a corresponding node when the two objects of the polygon soup do not collide with each other.

3. The parallel collision detection method as set forth in claim 1, wherein:
the load balancing comprises estimating the number of children nodes to be traversed, and equally distributing collision detection tasks to the respective threads; and
the estimating comprises determining a depth of the node using a penetration depth of the BVs.

4. The parallel collision detection method as set forth in claim 3, further comprising, when a relative value of the penetration depth of areas of the BVs is large, determining a large number of children nodes to be traversed, and enqueuing a left children node.

5. The parallel collision detection method as set forth in claim 4, wherein the left children node is traversed by threads other than a thread which traversed the parent node.

6. The parallel collision detection method as set forth in claim 5, wherein the thread which traversed the parent node recursively traverses a right side children node.

7. The parallel collision detection method as set forth in claim 4, wherein the relative value of the penetration depth is determined using following Equation:
$$\frac{ɛ D}{\sum \vert {r}_{a}^{j} \cdot D \vert + \sum \vert {r}_{b}^{i} \cdot D \vert} \geq α$$
where εD is the penetration depth between BVₐ and BV_{b}, ε is a shortest of differences between values obtained by projecting centers and radiuses of sides of the given two overlapping BVₐ and BV_{b} in 15 different axes, D is an axis corresponding to ε, rₐⁱ and r_{b}ⁱ are vectors which represent the radiuses of the respective sides of the BVₐ and BV_{b}, and α is a value designated by a user.

8. The parallel collision detection method as set forth in claim 7, wherein the left children node is traversed by threads other than a thread which traversed the parent node.

9. The parallel collision detection method as set forth in claim 8, wherein the thread which traversed the parent node recursively traverses a right side children node.

10. A parallel distance computation method using load balancing in order to compute distance between two objects of a polygon soup, the parallel distance computation method being processed in parallel using a plurality of threads, and the parallel distance computation method comprising:
traversing a BVTT using BVHs related to the polygon soup in a depth first search manner or a width first search manner;
computing an Euclidean minimum distance between two BVs in a node when a currently traversed node is an internal node, recursively traversing children nodes of the internal node (parent node) when the Euclidean minimum distance is smaller than a predetermined upper bound, and stopping to traverse the node when the currently traversed node is the internal node and the computed Euclidean minimum distance of the two BVs in the node is equal to or larger than the predetermined upper bound; and
computing a distance between the two objects of the polygon soup in a leaf node when the currently traversed node is the leaf node, and updating the predetermined upper bound using the computed distance when the computed distance is smaller than the predetermined upper bound.

11. The parallel distance computation method as set forth in claim 10, wherein:
the load balancing comprises estimating the number of children nodes to be traversed, and equally distributing distance computation tasks to the respective threads; and
the estimating comprises computing an estimation value of d(A,B) (d(·) is an operation used to obtain the Euclidean minimum distance, A and B are the two objects of the polygon soup) which has a predetermined weight, determining that any one of children nodes of a node {a,b} corresponds to the Euclidean minimum distance when an Euclidean minimum distance d(a,b) of the node {a,b} is smaller than the estimation value, and pushing a left children node to a stack.

12. The parallel distance computation method as set forth in claim 11, wherein the estimation value is obtained using following Equation:
Evaluation value=ωd(a₀,b₀)+(1−ω)σ
where {aₒ,bₒ} is a root node of the BVTT, ω is the predetermined weight, and σ is the predetermined upper bound.
